(19) United States
(12) Patent Application Publication
(10) Pub. No.: US 2005/0138571 A1
(43) Pub. Date: Jun. 23, 2005

(54) Dynamic detection of device characteristics

(76) Inventors: Dhananjay V. Keskar, Beaverton, OR (US); Matthew Hoekstra, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/741,305

(22) Filed: Dec. 18, 2003

(51) Int. Cl. G06F 17/00

(52) U.S. Cl. 715/789

(57) ABSTRACT

A mechanism that allows customization, adaptation and/or personalization of content provided to a client device by a server device based on one or more dynamically variable characteristics of the client device, for example, geographical location, network connection conditions, device configuration, user preferences. Information exchanged to enable customization is adapted based on a user's privacy preferences

### TECHNICAL FIELD

The invention relates to browser software. More particularly, the invention relates to techniques for dynamically detecting the capability of a client device.

### BACKGROUND

Browser applications (e.g., Web browsers such as Internet Explorer from Microsoft Corporation or Navigator from Netscape, Inc.) are commonly used to access information using a client in a client-server connection. The browser applications allow a user to access information from multiple servers using a standard interface. As browser applications have become increasingly popular, personalization of the browsing experience has been attempted to increase the ease and/or speed with which a user can access target information.

Current client browser applications rely on static data to provide information that can be used for personalized content. For example, a server can place a “cookie” on a client computer to store user preferences associated with a particular Web page, which can include, for example, the type of browser used and/or display formats. However, use of cookies provides only a limited enhancement to the browsing experience while also exposing the user to potential security threats.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of a client-server architecture in which a client device can provide dynamic content information.

FIG. 2 is one embodiment of a client-side Profile Framework architecture that can be used to provide dynamic client characteristics to a content provider.

FIG. 3 is a diagram of a first embodiment of a mechanism for providing dynamic client characteristics to a content provider.

FIG. 4 is a diagram of a second embodiment of a mechanism for providing dynamic client characteristics to a content provider.

FIG. 5 is a block diagram of one embodiment of a electronic system.

### DETAILED DESCRIPTION

Methods and apparatuses for dynamic detection and disclosure of client device characteristics and/or functionality are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Described herein is a mechanism that allows enhanced customization, adaptation and/or personalization of content provided to a client device by a server device based on one or more dynamically variable characteristics of the client device. In one embodiment, this can be provided by a client-side, script-based mechanism for making dynamically variable characteristics (e.g., geographical location, network connection conditions, device configuration, user preferences) available to the content provider (e.g., the server device). While this mechanism is broadly applicable, it is generally described below in terms of a Web-based client device having client-centric capabilities of interest accessible to the content provider during a browser session. Description of the disclosed mechanism with respect to a Web-based interaction is for ease of description purposes only and should not limit the scope of the invention.

For example, using the mechanisms described herein, a Web page provider offering a map and/or driving direction content can determine whether the client device has a location awareness capability. If the client device has location awareness capability information related to the device location can be used to customize content, for example, maps can be updated to show progress, or advertisements for establishments near the current location of the client device can be provided.

In one embodiment, the mechanism described herein can allow new device capabilities added by device makers and platform providers to be exposed uniformly for use by content and application providers. Further, privacy filters and/or other security constraints can be applied to control the flow of dynamic information based on, for example, device location or configuration.

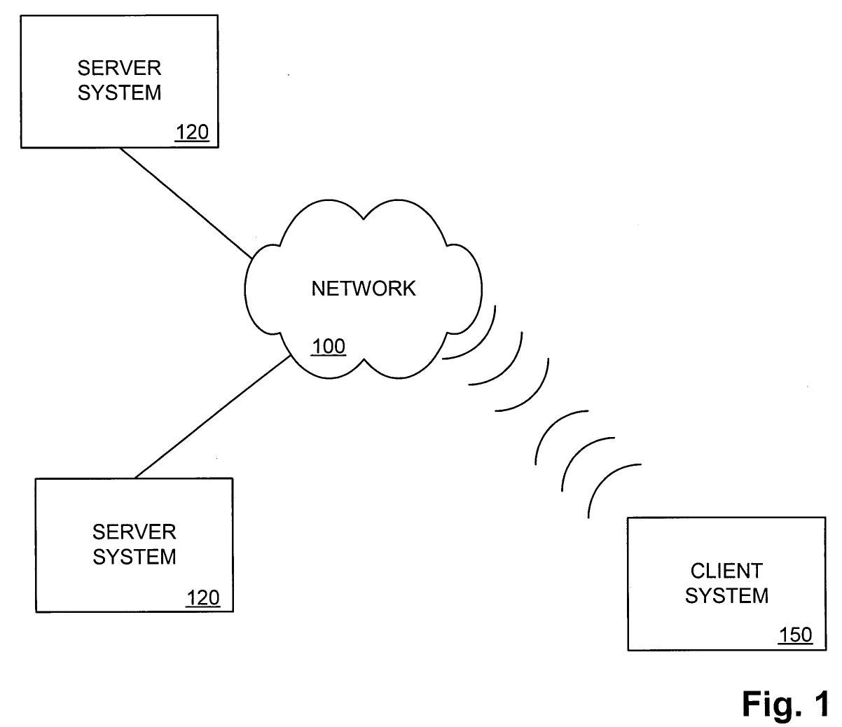

FIG. 1 is a block diagram of one embodiment of a client-server architecture in which a client device can provide dynamic content information. In the example of FIG. 1, the client system is illustrated with a wireless network connection; however, the client system can have a wired or a wireless network connection. Client system 150 can be any type of electronic system with a network interface. Thus, client system 150 can be, for example, a desktop computer system, a laptop computer system, a personal digital assistant (PDA), a cellular telephone, or a Global Positioning System (GPS) device.

Network 100 is intended to represent any interconnection of electronic devices, for example, a local area network or a wide area network. In some of the examples that follow, network 100 is the Internet; however, alternative networks (or groups of networks) can also be used. Server systems 120 are remote electronic systems not directly connected to client system 150 that provide information to client system 150 in response to a request from client system 150. One embodiment of an electronic system that can be used for either server systems or client systems is described in greater detail below. The server systems can provide customized content in response to dynamic client characteristics.

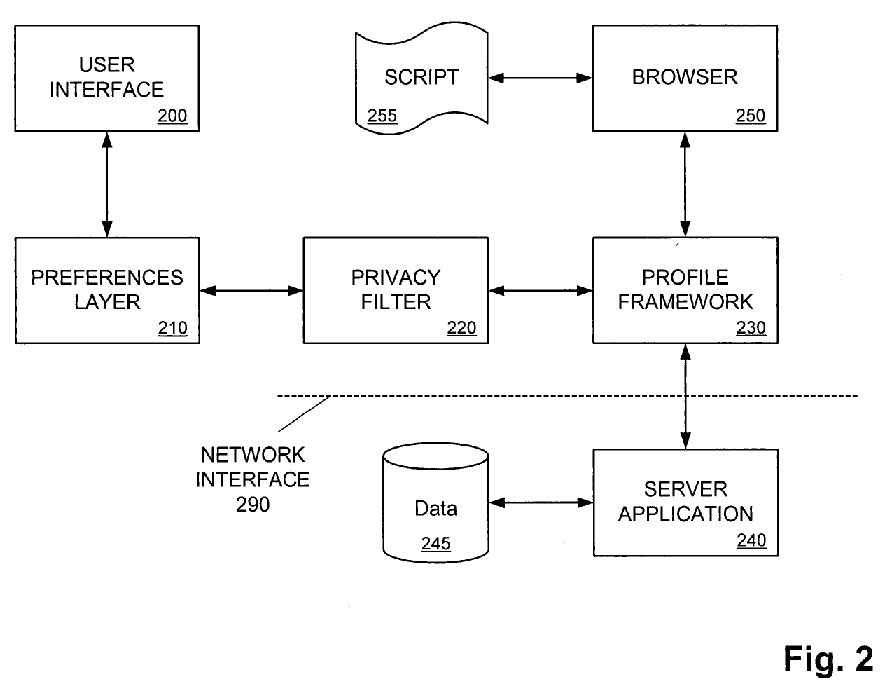

FIG. 2 is one embodiment of a client-side profile framework architecture that can be used to provide dynamic client characteristics to a content provider. User interface 200 allows a user to provide preference information to preferences layer 210. The preferences allow the user to provide criteria that can be used to determine what information is provided to content providers. Preferences layer 210 can also automatically generate preference information, for example, based on analysis of user activity.

Information from preferences layer 210 can be used to control the actions of privacy filter 220. As described in greater detail below, privacy filter 220 can be used to determine what, if any, information is transmitted to a content provider. For example, privacy filter 220 can include a list of trusted content providers that are allowed to receive geographic location information from a client device while the location information is not transmitted to content providers not on the list. Other types of criteria can also be used.

Privacy filter 220 is used by profile framework 230 to selectively transmit information related to dynamic client characteristics to content providers. Browser 250 operates with profile framework 230 to interact with server application 240 to access data 245 stored on a remote device over network interface 290. Browser 250 receives a request for information from server application 240 via a user interface. For example, browser 250 can have a graphical user interface that allows a user to provide a Uniform Resource Locator (URL) to initiate a request for information from server application 240.

As a specific example, server application 240 may provide a mapping and/or driving direction service. The user of browser 250 enters the URL of server application 240 into the browser interface. Browser 250 can pass the URL to profile framework 230, which determines whether the URL corresponds to a trusted content provider. If so, browser 250 can execute script 255, which determines a geographical location of the client device using, for example, a Global Positioning System (GPS) device. Determination of the geographical location can be accomplished in any manner known in the art.

The dynamic location information is provided by browser 250 to profile framework to server application 240. Using the location information, server application 240 retrieves data and provide content to browser 250 that is customized based on the geographical location of the client device.

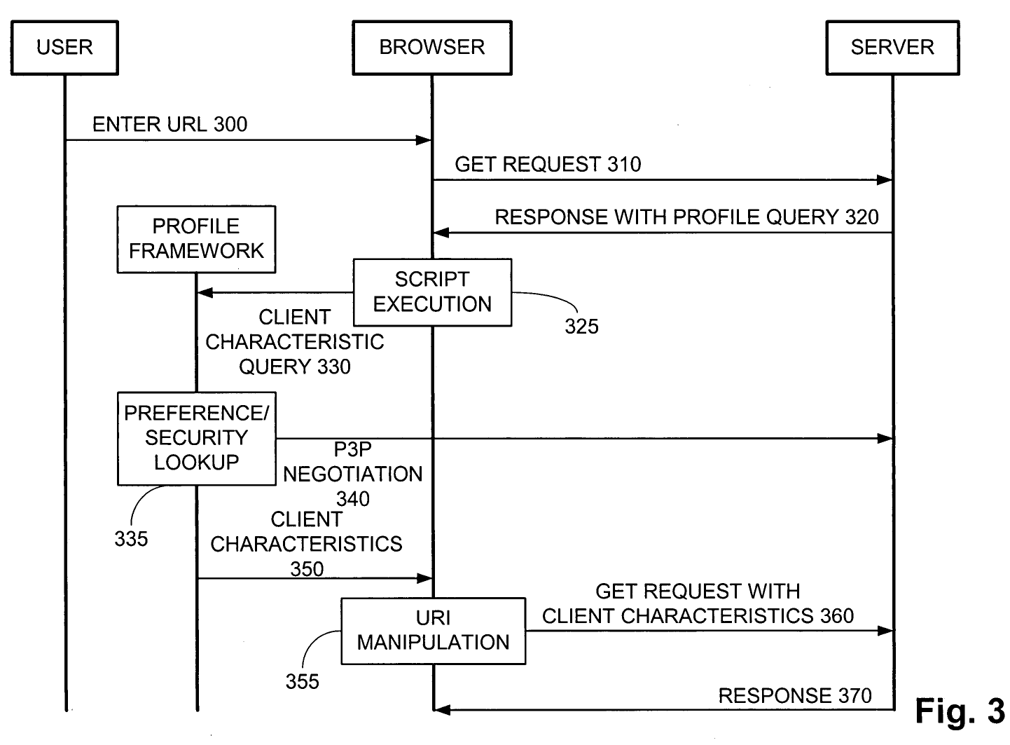

FIG. 3 is a diagram of a first embodiment of a mechanism for providing dynamic client characteristics to a content provider. A user enters a URL (or otherwise provides an indication of a desired server to be accessed) in a browser interface, 300. The URL can be, for example, “ . . . dynamicmaps.net . . . ” In one embodiment, using Hypertext Transfer Protocol (HTTP), the browser uses the URL to generate a GET request that is transmitted to the target server, 310. One implementation of HTTP is described in Internet Engineering Task Force (IETF) Request for Comments (RFC) 2616, entitled “Hypertext Transfer Protocol—HTTP/1.1,” published June, 1999. Other data transfer protocols can also be used.

The server provides a response message that includes a profile query, 320. The profile query requests information about the client device that can be used to generate content based on the results of the profile query. The information requested about the client device can be static in nature (e.g., type of processor, type of browser) or dynamic in nature (e.g., geographic location, network connection conditions). In one embodiment, in response to the profile query, the browser application executes a script, 325. In alternate embodiments, the script can be executed prior to receiving the profile query, for example, in response to the user entering the URL.

In one embodiment, the script execution causes a client characteristic query, 330, from the browser to the profile framework. In response to the client characteristic query, the profile framework (or other component of the client system running the browser) determines the status of a dynamically changeable client characteristic. For example, if the client characteristic query requests the geographic location of the client device, the profile framework can interact with a GPS or other device to determine the location of the client device.

As another example, if the client characteristic query requests the bandwidth provided by the current network connection, the profile framework or other component can run a diagnostic operation on the network interface to determine the bandwidth provided by the current connection. Any other type of dynamic characteristic can also be provided.

In one embodiment, upon determination of the requested characteristic, a lookup operation is performed, 335, to determine whether the client characteristic information should be provided to the server. The preference/security lookup allows a user to be selective in the information that is provided to a server. The preference/security lookup can be based on an approved list, a disapproved list, authentication results and/or any other preference security parameters.

In one embodiment, the profile framework operates using the Platform for Privacy Preferences (P3P) protocol to determine if the server security policies meet the user's privacy requirements. More information on P3P can be found in “The Platform for Privacy Preferences 1.0 (P3P1.0) Specification,” available from W3C and published Apr. 16, 2002. Other techniques and protocols can also be used for selectively transmitting client characteristics based on a user's preferences and/or security constraints.

The client characteristics are provided to the browser 350. In one embodiment, in response to the client characteristics, the browser manipulates a Uniform Resource Indicator (URI), 355, to generate a GET request that includes the client characteristics, 360. Using the example, above, the URI can be “ . . . dynamicmaps.net?lat=45.3&long=120.8&size=small . . . ” which indicates the geographical location (45.3° N. latitude and 120.8° longitude) as well as the size of the generated map (small). Other types of information can also be provided in the URI. In response to receiving the URI, the server provides a response with content selected based on a dynamic characteristic of the client device, 370.

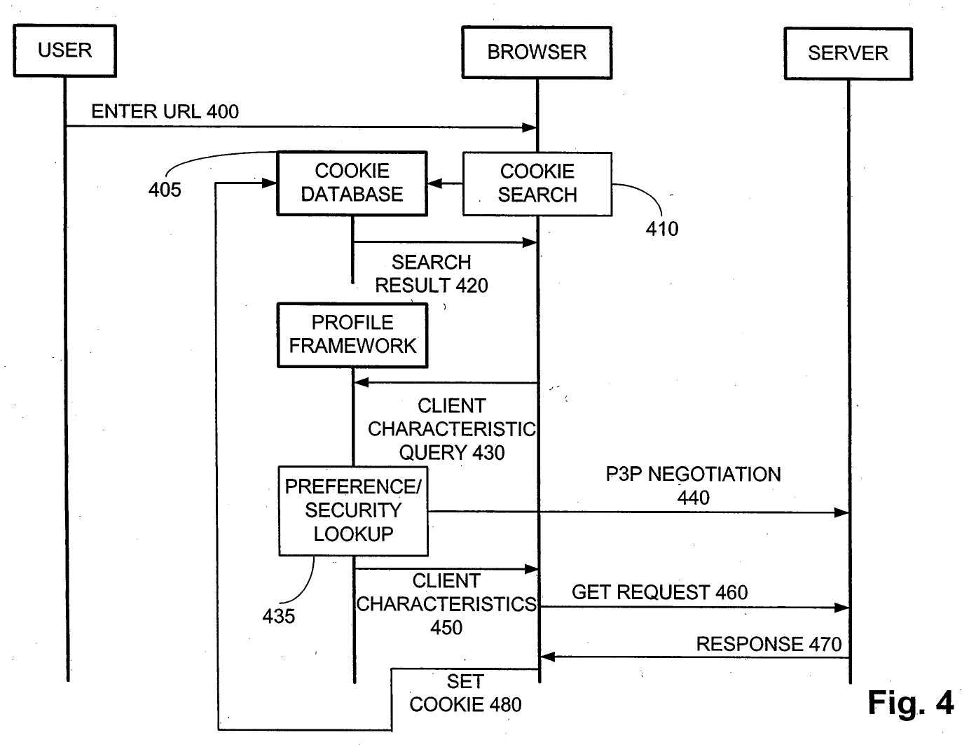

FIG. 4 is a diagram of a second embodiment of a mechanism for providing dynamic client characteristics to a content provider. A user enters a URL (or otherwise provides an indication of a desired server to be accessed) in a browser interface, 400. In response to receiving the URL, the browser performs a “cookie search” to determine whether the client device is storing a cookie corresponding to the URL, 410. Searches for other data segments associated with a URL can also be performed; the invention is not limited to use of cookies.

In one embodiment, the browser accesses cookie database, 405 to determine whether the client is storing a cookie corresponding to the entered URL, and the search results are provided to the browser, 410. In one embodiment, the stored cookies indicate the dynamic characteristics to be checked and transmitted to the server corresponding to the URL. A cookie can take the form, for example, of:
{{platform.location}}
last.visit=11-11-03
   where the lines between double braces, “{{ . . . }}”, correspond to dynamically determined characteristics. In this example, the location of the client device is determined after receiving the URL and before generating the GET request.

The browser performs a client characteristic query, 430, to determine the requested characteristics (e.g., client device location). In one embodiment, upon determination of the requested characteristic, a lookup operation is performed, 435, to determine whether the client characteristic information should be provided to the server. The preference/security lookup allows a user to be selective in the information that is provided to a server. In one embodiment, the browser performs a P3P negotiation with the server, 440, to determine whether the server provides acceptable security assurances.

The client characteristics are provided to the browser 450. In one embodiment, the browser uses the client characteristics to modify the cookie to be transmitted with the URL to the server. Thus, after determining the location of the client device, the browser can send the following cookie to the server:
location=97006
last.visit=11-11-03
   Thus, the cookie can provide the ZIP code of the geographic location of the client device. The latitude and longitude corresponding to the client device location can also be provided in the cookie.

The browser generates a GET request using the URL and the cookie, 460. In response to receiving the URL and the cookie, the server provides a response with content selected based on a dynamic characteristic of the client device, 470. Upon receiving the response, the browser can set a cookie having an indication of the dynamic characteristic to be determined, for example,
{{platform.location}}
last.visit=11-11-03
   in cookie database 405.

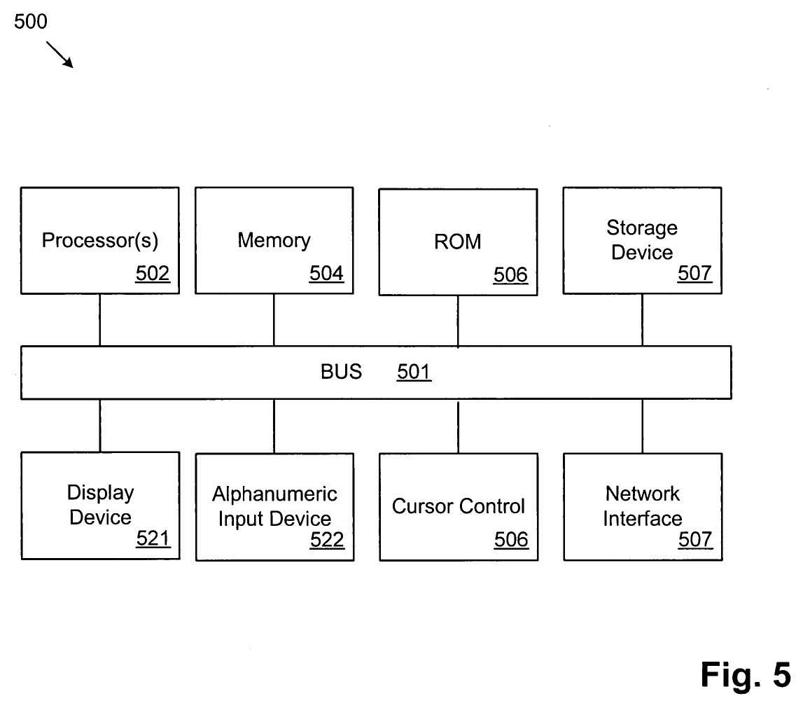

FIG. 5 is a block diagram of one embodiment of a electronic system. The electronic system illustrated in FIG. 5 is intended to represent a range of electronic systems. Alternative electronic systems can include more, fewer and/or different components.

Electronic system 500 includes bus 501 or other communication device to communicate information, and processor 502 coupled to bus 501 to process information. While electronic system 500 is illustrated with a single processor, electronic system 500 can include multiple processors and/or co-processors. Electronic system 500 further includes random access memory (RAM) or other dynamic storage device 504 (referred to as memory), coupled to bus 501 to store information and instructions to be executed by processor 502. Main memory 504 also can be used to store temporary variables or other intermediate information during execution of instructions by processor 502.

Electronic system 500 also includes read only memory (ROM) and/or other static storage device 506 coupled to bus 501 to store static information and instructions for processor 502. Data storage device 507 is coupled to bus 501 to store information and instructions. Data storage device 507 such as a magnetic disk or optical disc and corresponding drive can be coupled to electronic system 500.

Electronic system 500 can also be coupled via bus 501 to display device 521, such as a cathode ray tube (CRT) or liquid crystal display (LCD), to display information to a user. Alphanumeric input device 522, including alphanumeric and other keys, is typically coupled to bus 501 to communicate information and command selections to processor 502. Another type of user input device is cursor control 523, such as a mouse, a trackball, or cursor direction keys to communicate direction information and command selections to processor 502 and to control cursor movement on display 521. Electronic system 500 further includes network interface 530 to provide access to a network, such as a local area network.

Instructions are provided to memory from a storage device, such as magnetic disk, a read-only memory (ROM) integrated circuit, CD-ROM, DVD, via a remote connection (e.g., over a network via network interface 530) that is either wired or wireless, etc. In alternative embodiments, hard-wired circuitry can be used in place of or in combination with software instructions. Thus, execution of sequences of instructions is not limited to any specific combination of hardware circuitry and software instructions.

An electronically-accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method comprising:
transmitting, from a local electronic device, a request for the information to a remote electronic device;
receiving, from the remote electronic device, a response including a profile query requesting data corresponding to one or more dynamically changeable characteristics of the local electronic device;
retrieving the requested data corresponding to the one or more dynamically changeable of characteristics of the local electronic device; and
selectively transmitting, from the local electronic device, a request for the information including the data corresponding to the one or more dynamically changeable characteristics of the local electronic device based on one or more privacy constraints.

2. The method of claim 1 wherein the request for information comprises entering a Uniform Resource Locator (URL) into a browser interface.

3. The method of claim 1 wherein the request for information comprises selecting a link via a browser interface.

4. The method of claim 1 wherein the dynamically changeable characteristics comprise one or more of: a geographical location of the local electronic device, a network connection used by the local electronic device, a user preference profile stored by the local electronic device, and a connectivity condition corresponding to a network connection used by the local electronic device.

5. A method comprising:
receiving, from a remote electronic device, a request for information from a local resource;
transmitting to the remote electronic device a response including a profile query requesting data corresponding to one or more dynamically changeable characteristics of the remote electronic device;
receiving, from the remote electronic device, a request for the information including the data corresponding to the one or more dynamically changeable characteristics of the remote electronic device; and
transmitting to the remote electronic device the requested information selected and/or formatted based on the data corresponding to the one or more dynamically changeable characteristics of the remote electronic device.

6. The method of claim 5 wherein the request for information comprises entering a Uniform Resource Locator (URL) into a browser interface.

7. The method of claim 5 wherein the request for information comprises selecting a link via a browser interface.

8. The method of claim 5 wherein the dynamically changeable characteristics comprise one or more of: a geographical location of the local electronic device, a network connection used by the local electronic device, a user preference profile stored by the local electronic device, and a connectivity condition corresponding to a network connection used by the local electronic device.

9. An article comprising a computer-readable medium having stored thereon instructions that, when executed, cause one or more processors to:
transmit, from a local electronic device, a request for the information to a remote electronic device;
receive, from the remote electronic device, a response including a profile query requesting data corresponding to one or more dynamically changeable characteristics of the local electronic device;
retrieve the requested data corresponding to the one or more dynamically changeable of characteristics of the local electronic device; and
selectively transmit, from the local electronic device, a request for the information including the data corresponding to the one or more dynamically changeable characteristics of the local electronic device based on one or more privacy constraints.

10. The article of claim 9 wherein the request for information comprises entering a Uniform Resource Locator (URL) into a browser interface.

11. The article of claim 9 wherein the request for information comprises selecting a link via a browser interface.

12. The article of claim 9 wherein profile query includes an indication of a selected characteristic from the one or more dynamically changeable characteristics including at least a geographical location of the local electronic device, a bandwidth corresponding to a network connection used by the local electronic device, a user preference profile stored by the local electronic device, and a connectivity condition corresponding to a network connection used by the local electronic device.

13. An article comprising a computer-readable medium having stored thereon instructions that, when executed, cause one or more processors to:
receive, from a remote electronic device, a request for information from a local resource;
transmit to the remote electronic device a response including a profile query requesting data corresponding to one or more dynamically changeable characteristics of the remote electronic device;
receive, from the remote electronic device, a request for the information including the data corresponding to the one or more dynamically changeable characteristics of the remote electronic device; and
transmit to the remote electronic device the requested information selected and/or formatted based on the data corresponding to the one or more dynamically changeable characteristics of the remote electronic device.

14. The article of claim 13 wherein the request for information comprises entering a Uniform Resource Locator (URL) into a browser interface.

15. The article of claim 13 wherein the request for information comprises selecting a link via a browser interface.

16. The article of claim 13 wherein the dynamically changeable characteristics comprise one or more of: a geographical location of the local electronic device, a network connection used by the local electronic device, a user preference profile stored by the local electronic device, and a connectivity condition corresponding to a network connection used by the local electronic device.

17. A method comprising:
receiving, with an application executed by a local electronic device, a request for information to a remote electronic device;
searching a database of locally stored data corresponding to one or more remote content providers to determine whether to transmit data corresponding to one or more dynamically changeable characteristics of the local electronic device to the remote device with the request for information;
retrieving the locally stored data, if any, corresponding to the one or more dynamically changeable of characteristics of the local electronic device; and
transmitting, from the local electronic device, a request for the information including the data corresponding to the one or more dynamically changeable characteristics of the local electronic device.

18. The method of claim 17 wherein the locally stored data comprises a cookie.

19. The method of claim 17 wherein the dynamically changeable characteristics comprise one or more of: a geographical location of the local electronic device, a network connection used by the local electronic device, a user preference profile stored by the local electronic device, and a connectivity condition corresponding to a network connection used by the local electronic device.

20. An article comprising a computer-readable medium having stored thereon instructions that, when executed, cause one or more processors to:
receive, with an application executed by a local electronic device, a request for information to a remote electronic device;
search a database of locally stored data corresponding to one or more remote content providers to determine whether to transmit data corresponding to one or more dynamically changeable characteristics of the local electronic device to the remote device with the request for information;
retrieve the locally stored data, if any, corresponding to the one or more dynamically changeable of characteristics of the local electronic device; and
transmit, from the local electronic device, a request for the information including the data corresponding to the one or more dynamically changeable characteristics of the local electronic device.

21. The article of claim 20 wherein the locally stored data comprises a cookie.

22. The article of claim 20 wherein the dynamically changeable characteristics comprise one or more of: a geographical location of the local electronic device, a network connection used by the local electronic device, a user preference profile stored by the local electronic device, and a connectivity condition corresponding to a network connection used by the local electronic device.
